(19) United States
(12) Patent Application Publication
(10) Pub. No.: US 2006/0017588 A1
(43) Pub. Date: Jan. 26, 2006

(54) Congestion clock

(75) Inventor: Steven R. Hilliard, Knoxville, TN (US)

Correspondence Address: PITTS AND BRITTIAN P C, P O BOX 51295, KNOXVILLE, TN, 37950-1295, US

(73) Assignee: Inductive Signature Technologies, Inc., Knoxville, TN (US)

(21) Appl. No.: 10/897,613

(22) Filed: Jul. 23, 2004

(51) Int. Cl. G08G 1/123; G08G 1/00; G08G 1/09

(52) U.S. Cl. 340/995.13; 340/905; 701/117

(57) ABSTRACT

Methods and apparatus for presenting time-based and location-based traffic condition information to motorists. Traffic condition information is collected to create historical time-based and location-based traffic data, which is displayed, in one embodiment, on a congestion clock. The traffic condition data includes, in various embodiments, speed data, volume data, occupancy data, and travel time for a specific section of roadway.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to methods and apparatus for presenting time-based route condition information to motorists. More particularly, this invention pertains to an information processing and display system for collected and compiled traffic information, including speed, volume, occupancy information and travel time. The traffic information includes real-time data, historical data, and/or forecast data.

2. Description of the Related Art

Motorists, when presented with current traffic condition information, are able to change their route to avoid congested areas. Traffic designers, when presented with historic traffic condition information, are able to better design roadways. Various apparatus and methods are known for acquiring and presenting information relating to roads and traffic. The following United States Patents are representative of those apparatus and methods.

U.S. Pat. No. 5,673,039, titled “Method of monitoring vehicular traffic and of providing information to drivers and system for carrying out the method,” issued to Pietzsch, et al., on Sep. 30, 1997, discloses displaying road and traffic conditions over luminescent elements with signal lamps distributed at intervals along the road. The luminescent elements are illuminated simultaneously or in sequence for providing continuous traffic information.

U.S. Pat. No. 6,466,862, titled “System for providing traffic information,” issued to DeKock, et al., on Oct. 15, 2002, discloses providing traffic information to mobile users connected to a network. The mobile users have a display, a global positioning system receiver, and a communicating device to allow each of the mobile user stations to send and receive signals. Upon request of the mobile user station, the mobile user station receives and displays graphically information representative of selected portions of a map database and selected portions of the traffic information database. U.S. Pat. No. 6,574,548, titled “System for providing traffic information,” issued to DeKock, et al., on Jun. 3, 2003, is a continuation of U.S. Pat. No. 6,466,862.

U.S. Pat. No. 6,519,884, titled “Street and road sign,” issued to Duhamel on Feb. 18, 2003, discloses a road sign having a primary traffic symbol and a secondary traffic symbol wherein the secondary traffic symbol is unrelated to the primary traffic symbol, but provides information to drivers approaching the road sign.

U.S. Pat. No. 6,744,379, titled “System and method for displaying radar data,” issued to Aker, et al., on Jun. 1, 2004, discloses a system for processing and displaying radar data that allows radar data from more than one antenna to be simultaneously processed and displayed. One embodiment allows an operator to simultaneously view radar data for vehicles in the same lane, in the opposite lane, in front of the reference point, behind the reference point, and in other suitable locations.

U.S. Pat. No. 6,747,574, titled “Traffic control device transmitter, receiver, relay and display system,” issued to Butzer, et al., on Jun. 8, 2004, discloses a traffic control device information display system. The system includes a receiver that receives information from a transmitter for a traffic control device, a processor that processes the information to determine identification and location information for the traffic control device, and a display that displays the identification and the location information to an operator.

### BRIEF SUMMARY OF THE INVENTION

Methods and apparatus for presenting time-based and location-based traffic condition information to motorists are provided. Traffic condition information is collected to create historical time-based and location-based traffic data. The traffic data includes, in various embodiments, speed data, volume data, occupancy data, and travel time data. In one embodiment, the historical time-based and location-based traffic data is presented on a congestion clock. In various embodiments, the congestion clock is suitable for posting on the roadway, for printing on maps and brochures, and for displaying on a computer display.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a histogram of traffic speed data for a 24 hour period;

FIG. 2 is a histogram of traffic volume data for a 24 hour period;

FIG. 3 is a histogram of traffic occupancy data for a 24 hour period;

FIG. 4 is a flow diagram of one embodiment of collecting and displaying traffic data;

FIG. 5 is a pictorial representation of one embodiment of displaying historical traffic data;

FIG. 6 is a flow diagram of one embodiment of acquiring and storing data;

FIG. 7 is a flow diagram of one embodiment of a network for storing and presenting data;

FIG. 8 is a flow diagram of one embodiment of displaying user selected data; and

FIG. 9 is a pictorial representation of a second embodiment of displaying historical traffic data.

### DETAILED DESCRIPTION OF THE INVENTION

Methods and apparatus for presenting time-based and location-based traffic condition information is disclosed. Traffic data is collected for many roadways. The traffic data includes, in various embodiments, speed data, volume data, occupancy data, and travel time data.

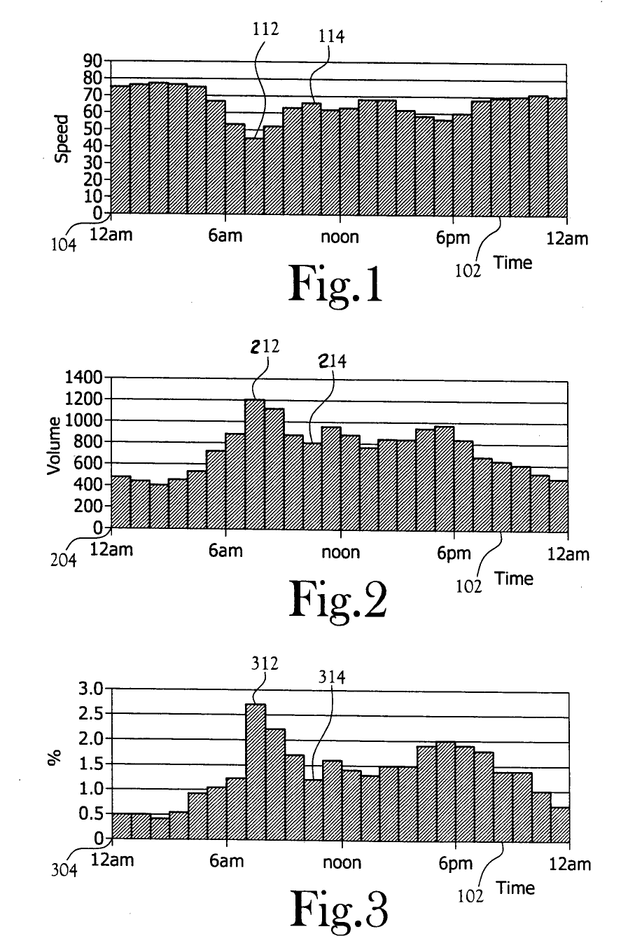

FIG. 1 illustrates a histogram of traffic speed data for a 24 hour period. The abscissa, or X-axis, 102 shows time for a 24 hour period, divided into one-hour increments. The ordinate, or Y-axis, 104 shows speed, which in the illustrated chart is measured in miles per hour. The data 112, 114 is representative of one-hour averages for a single lane of roadway. In one embodiment, this data is collected by monitoring vehicle speed road sensors installed in individual lanes of road. Speed is the velocity of a vehicle as it passes a vehicle speed road sensor.

The data 112 collected for the hour between 7 am and 8 am shows that the average speed over the sensor for that lane has fallen to 45 miles per hour (mph). Two hours later, between 10 am and 11 am, the data 114 shows that the average speed has increased to 66 mph. One explanation for the variation in speed is that morning rush-hour traffic has caused the average speed of the vehicles to drop, and the speed picks up after the rush-hour is over.

In various embodiments, the data is averaged over various times. In still another embodiment, the data is not averaged, but is collected as the instantaneous speed value for a specific time. If the speeds for every lane of a multiple lane roadway are averaged, an average speed for one direction of a planning because a motorist may decide to use an alternate route if the average speed is less than is desired.

FIG. 2 illustrates a histogram of traffic volume data for a 24 hour period. The abscissa, or X-axis, 102 is time for a 24 hour period, divided into one-hour increments. The ordinate, or Y-axis, 204 is volume, which in the illustrated chart is measured in vehicles per hour passing a specific point. The data 212, 214 is representative of one-hour averages of the number of vehicles driving on a single lane of roadway. In one embodiment, this data is collected by monitoring vehicle road sensors installed in individual lanes of road. Volume is the number of vehicles passing a specific point in the roadway over a specified time.

The data 212 collected for the hour between 7 am and 8 am shows that the average number of vehicles passing over the sensor for that lane has increased to 1200 vehicles per hour. Two hours later, between 10 am and 11 am, the data 214 shows that the average number of vehicles has fallen to 800 vehicles per hour. One explanation for the variation in volume is that the number of vehicles has increased because of a morning rush hour. The volume drops after the rush hour is over.

In various other embodiments, the data is averaged over various times. If the volume measurements for every lane of a multiple lane roadway are averaged, an average volume for one direction of a roadway is determined. This information is valuable to motorists during pre-trip planning because a motorist may decide to use an alternate route if the roadway is congested, as shown by a high volume.

FIG. 3 illustrates a histogram of traffic occupancy data for a 24 hour period. The abscissa, or X-axis, 102 is time for a 24 hour period, divided into one-hour increments. The ordinate, or Y-axis, 304 is percent of occupancy, which in the illustrated chart is shown as a percentage. The data 312, 314 is representative of one-hour averages of the occupancy level on a single lane of roadway. In one embodiment, this data is collected by monitoring vehicle road sensors installed in individual lanes of road. Occupancy is the percentage of a section of roadway that is occupied by vehicles. For example, if a one-mile (5280 feet) section of road has an occupancy of 1 percent, then that section of roadway contains a number of vehicles that, if placed end-to-end, stretches 528 feet in length. Occupancy is determined by the percent of on-time of a vehicle presence detector. Section density is the number of vehicles per unit length of road.

The data 312 collected for the hour between 7 am and 8 am shows an occupancy of 2.7 percent. Two hours later, between 10 am and 11 am, the data 314 shows that the average occupancy has fallen to 1.2 percent. One explanation for the variation in occupancy is that the vehicle density has increased because of a morning rush hour. The occupancy drops after the rush hour is over.

In various other embodiments, the data is averaged over various times. If the occupancy measurements for every lane of a multiple lane roadway are averaged, an average occupancy for one direction of a roadway is determined. This information is valuable to motorists during pre-trip planning because a motorist may decide to use an alternate route if the roadway is congested, as shown by a high occupancy.

Traffic patterns, such as those identified above in FIGS. 1 to 3, are classed as either free-flow or congested conditions. Congestion is further classed as recurring and as non-recurring. Recurring congestion conditions are those conditions that occur with a regular pattern, such as caused by a morning rush hour that occurs from Monday through Friday. Non-recurring congestion conditions are those conditions that do not occur with any predictable regularity. An example of a non-recurring congestion is an accident that causes traffic to slow or even come to a complete stop for a period. Although accidents are known to occur at a specified rate on certain roadways, the future time of an accident cannot be predicted.

As used herein, a section of roadway varies from a single point to a stretch of roadway. For example, in one embodiment, the road sensors 602 measuring speed, volume, and occupancy are point measures and return information relating to a specific point of roadway. In another embodiment, travel time is the average time a vehicle takes to travel from one point to another. Accordingly, travel time refers to a section of roadway that is defined by a length. Also, road and roadway are used interchangeably.

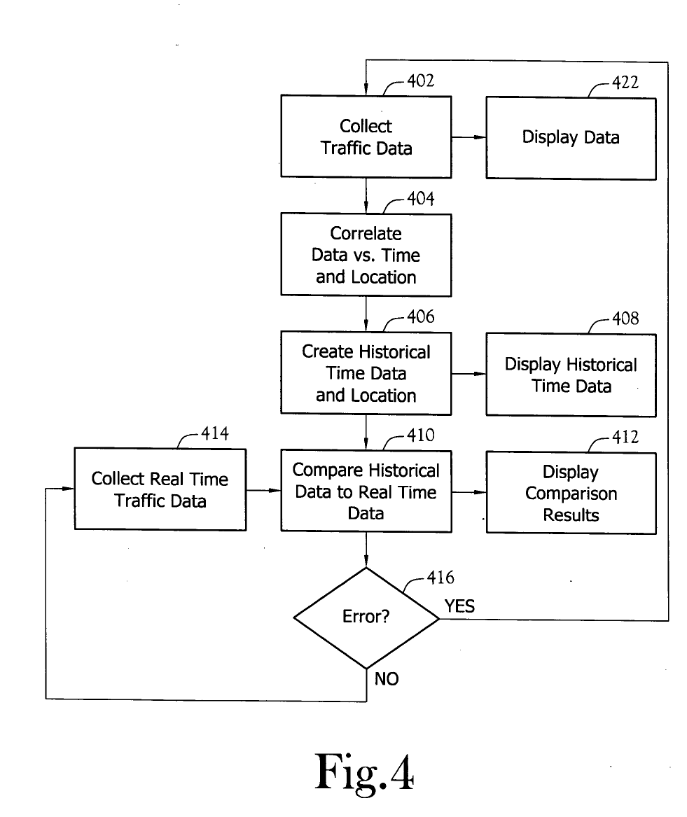

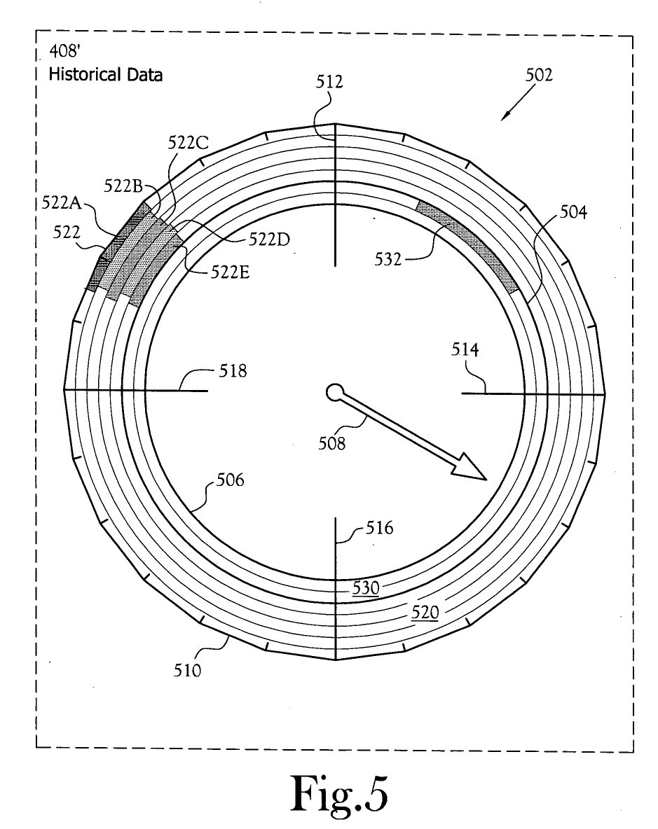

FIG. 4 illustrates a flow diagram of one embodiment of collecting and displaying traffic data. The first step is to collect traffic data 402. In various embodiments, the traffic data includes one or more of speed, volume, occupancy data, and travel time data. The collected traffic data, in one embodiment, is displayed 422. The second step is to correlate the collected data versus time and location 404. The correlation step 404 results in data as illustrated in FIGS. 1 to 3. The next step is to create a set of historical time data 406. In one embodiment, the step of creating historical data sets 406 includes determining the regular traffic pattern for a period. In one embodiment, the set of historical time data is displayed 408.

Real time traffic data is collected 414 and, after the creation of historical data sets 406, a step of comparing the historical data to the real time data 410 is performed. In one embodiment, the comparison results are displayed 412.

The comparison of historical to real time data 410 produces an error value. If the error value exceeds a preset level 416, the latest real time data is collected 402 and the process repeats to create new historical time data 406. If the error is low or within acceptable limits, then additional real time data is collected 414. In the illustrated embodiment, the historical time data is verified with real time data to ensure that changes in traffic patterns are reflected in the historical time data.

FIG. 5 illustrates a pictorial representation of one embodiment of displaying historical traffic data 408′. In this embodiment, the historical traffic data is presented on a 24-hour clock face, or congestion clock, 502. Noon 512 is represented at the top of the clock face 502, with 6 pm 514 at the extreme right, midnight 516 at the bottom, and 6 am 518 at the extreme left of the clock face 502. In the illustrated embodiment, tic marks 512, 514, 516, 518 are used to indicate the hours. In other embodiments, the time is delineated with numbers or other indicia. In still other embodiments, the congestion clock 502 is a 12-hour clock, for example, showing only am or pm hours. In this embodiment, two clocks 502 can be located adjacent or sequentially to show a 24-hour period. In the illustrated embodiment, the outside perimeter 510 of the clock 502 is a 24-sided polygon. In other embodiments, the outside perimeter 510 is a polygon with a number of sides corresponding to the number of hours depicted or is a circle.

In the illustrated embodiment, an hour hand 508 points to 8 pm, which would be the current time, thereby orienting the user to the display 408′ and also teaching the meaning or interpretation of the clock indicia. In one embodiment, the clock face 502 is printed on a sign or billboard and the hour hand 508 is moved with a clock drive. In another embodiment, the clock face 502 is printed on a sign posted alongside a roadway and contains traffic data for that section of the roadway.

In the illustrated embodiment, the historical data is presented close to the outside perimeter 510 of the clock 502. A weekday data display area 520 is defined between the outside perimeter 510 of the clock 502 and a first inside line 504. The weekday display area 520 is further divided into five annular areas, each one representing one day of the work week, that is, Monday through Friday. A weekend data display area 530 is defined between the first inside line 504 and a second inside line 506. The weekend display area 530 is further divided into two annular areas representing Saturday and Sunday. In the illustrated embodiment, the annular areas or rings are separated by circles. In another embodiment, the weekday data display area 520 and the weekend display area 530 are not further divided by visible circles; however, the traffic condition data 522, 532 are illustrated as if the there were discrete annular rings.

In the illustrated embodiment, morning rush hour traffic data 522 is indicated between about 7:30 am and 9:30 am in the weekday data display area 520. A first segment 522A represents regular congested traffic conditions for Monday, a second segment 522B represents Tuesday congestion, a third segment 522C represents Wednesday congestion, a forth segment 522D represents Thursday congestion, and a fifth segment 522E represents Friday congestion. In another embodiment, the data for the individual days are combined into one segment 522 filling the appropriate times of the weekday display area 520. This embodiment is appropriate for those instances when there is no appreciable difference between the days in the weekday display area 520.

The clock face 502 also includes a segment 532 showing traffic congestion for Saturday around 1 pm to 2 pm. In one embodiment this data 532 represents irregular traffic conditions, such as from an accident. In another embodiment, such irregular traffic conditions are not displayed because such segments 532 do not provide any forecasting benefit. In still another embodiment, the segment 532 represents regular traffic conditions, for example, a stadium that holds regularly scheduled events on Saturday afternoons. In this embodiment, the display of segment 532 provides a forecasting benefit.

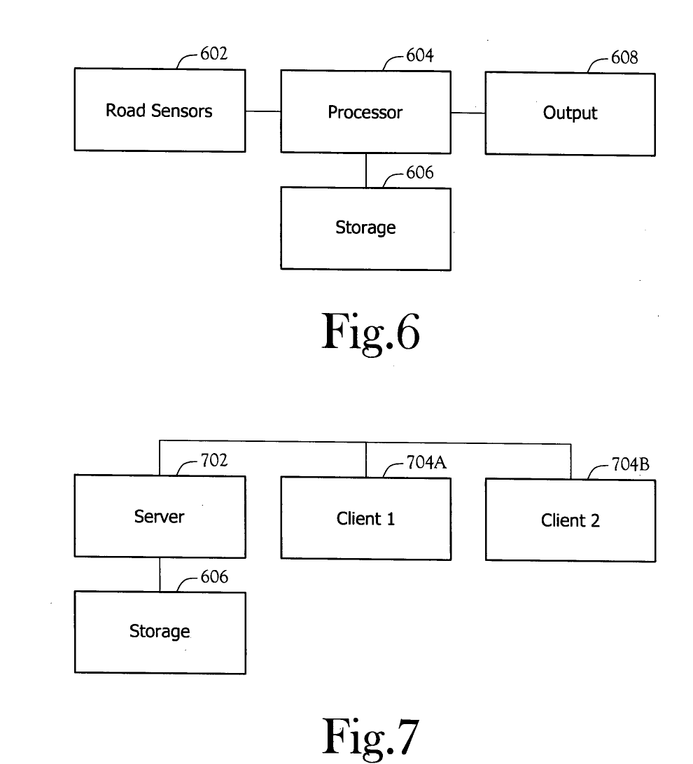

FIG. 6 illustrates a flow diagram of one embodiment of acquiring and storing traffic data. Road sensors 602 are positioned upon selected portions of roadways and provide an input signal to a processor 604. The processor 604 performs data acquisition and stores the sensor data in a storage device 606. The processor 604 also processes the sensor data to create the historical time data for the monitored section of road, and this information is also stored in the storage unit 606. The processor 604 provides an output 608.

As used herein, the processor 604 should be broadly construed to mean any computer or component thereof that executes software. The processor 604 includes a memory medium that stores software, a processing unit that executes the software, and input/output (I/O) units for communicating with external devices. Those skilled in the art will recognize that the memory medium associated with the processor 604 can be either internal or external to the processing unit of the processor without departing from the scope and spirit of the present invention.

In one embodiment the processor 604 is a general purpose computer, in another embodiment, it is a specialized device for implementing the functions of the invention. Those skilled in the art will recognize that the processor 604 includes an input component, an output component, a storage component, and a processing component. The input component receives input from external devices, such as the road sensors 602. The output component sends output to external devices, such as the output device 608, which can be a video display unit or a printer. The storage component stores data and program code. In one embodiment, the storage component includes random access memory. In another embodiment, the storage component includes non-volatile memory, such as floppy disks, hard disks, and writeable optical disks. The processing component executes the instructions included in the software and routines.

FIG. 7 illustrates a flow diagram of one embodiment of a simplified network for storing and presenting data. A server 702 with access to the data storage device 606 communicates with clients 704A, 704B connected to the network. In one embodiment, the server 702 and clients 704 communicate over the Internet.

The data storage device 606 is any of various devices known in the art for storing data, such as, but not limited to, a hard disk, a network attached storage device (NAS), recordable optical disks, and a stand-alone networked data storage device. Although FIG. 7 illustrates the data storage device 606 communicating directly with the server 702, in another embodiment, the data storage device 606 is connected to the network directly and communicates with the server 702 via the network.

Further, as used herein, a “client” should be broadly construed to mean any computer or component thereof directly or indirectly connected or connectable in any known or later-developed manner to a computer network, such as the Internet or a local area network. Examples of a client include, but are not limited to, a personal computer, a terminal that communicates over the Internet, an Internet connected television, and a web-enabled cell-phone, PDA, or DSRC (Dedicated Short Range Communications) device. The client 704 runs, or executes, software that communicates with the server 702. The term “server” should also be broadly construed to mean a computer, computer platform, an adjunct to a computer or platform, or any component thereof that provides data or information to a client 704. The server 702 runs, or executes, software that allows it to properly handle and process client requests in addition to other processes necessary for the server 702 to perform its required functions. Of course, a client 704 should be broadly construed to mean the equipment that requests or gets a file or information, and a server 702 is the equipment that provides the file or information. These terms are based on the function of the associated equipment and the terms may interchange as the function of a particular piece of equipment changes.

For an HTML (hypertext markup language) based system, the client 704 runs or executes software that communicates with the server 702. The client software is typically known as browser software, and in one embodiment, is a standard web browser such as Netscape or Microsoft Internet Explorer. In other embodiments, custom software performs the functions of the browser software. The browser software executes on the client 704 and performs the functions of communicating with the server 702, displaying data and information provided by the server 702, sending user input from the client 704 to the server 702, and processing applets or sub-routines. Browser applets or sub-routines are programs executed on the client 704 that are controlled by the browser software to perform special functions not normally available in the browser software.

In one embodiment, each of the identified functions are performed by one or more software routines executed by the processor 604 and/or the server 702. In another embodiment, one or more of the functions identified are performed by hardware and the remainder of the functions are performed by one or more software routines run by the processor 608 and/or the server 702.

The processor 604 and the server 702 execute software, or routines, for performing various functions. These routines can be discrete units of code or interrelated among themselves. Those skilled in the art will recognize that the various functions can be implemented as individual routines, or code snippets, or in various groupings without departing from the spirit and scope of the present invention. As used herein, software and routines are synonymous. However, in general, a routine refers to code that performs a specified function, whereas software is a more general term that may include more than one routine or perform more than one function.

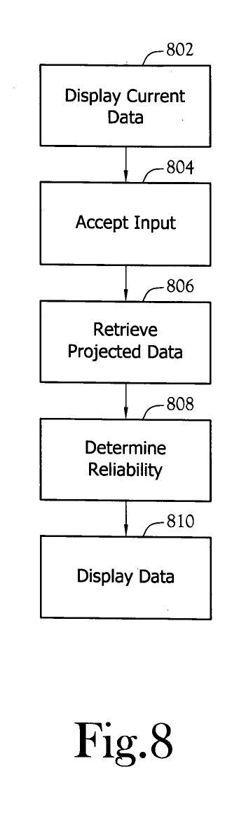

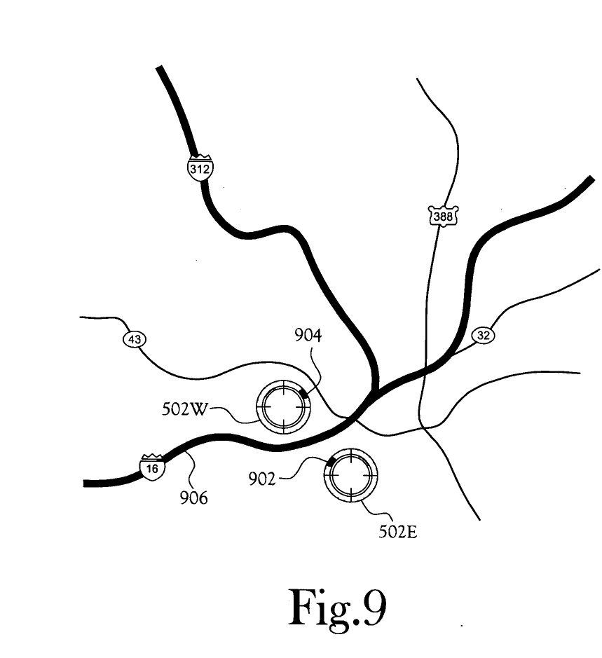

FIG. 8 illustrates a flow diagram of one embodiment of the steps for displaying user selected data from a client 704. The user selected data, in one embodiment, includes data representing a forecast of traffic conditions for a selected time period. In one such embodiment, the user selected data is presented as a color-coded map indicating the portions of the roadway that are congested. In another such embodiment, the user selected data is presented as a map with congestion clocks 502 adjacent the road segments, as illustrated in FIG. 9. In still another such embodiment, the user selected data is presented as a set of tabular data of road segments and amount of congestion.

In one embodiment, the server 702 is a web server operating over the Internet and a user accesses the server 702 at a client 704A through a browser. From the client 704, the user displays current data 802. In one embodiment, this is performed by requesting a web page that contains a representation of real time traffic data. The next step is to accept input 804 from the user. In one embodiment, the user is presented with prompts for inputting data, which the server 702 accepts 804. In various embodiments this input can be from selection of predefined periods or by entering a date and time of a forecast.

The server 702 retrieves the requested projected data 806. In one embodiment, the step of retrieval 806 includes correlating the traffic data versus time and location 404 and creating the historical time data 406. In another embodiment, the step of retrieval 806 includes retrieving previously determined data 404, 406 from a data storage device 606.

Another step for the server 702 is to determine the reliability of the forecast data 808. In one embodiment, reliability information is determined by comparing the historical time-based data against the most recent real-time data for the corresponding time period. The amount of deviation correlates inversely to a reliability factor, which provides information to the user as how reliable the forecast data is. In another embodiment, the reliability information is determined by comparing the average historical time-based data against the most recent real-time data for the corresponding time period. In this embodiment, the effect of irregular data is minimized. In one embodiment, reliability information includes the standard deviation of traffic conditions from one week to another at the same time of day and/or day of the week. In another embodiment, reliability information includes a scale value indicating a range of reliability from high to low. Reliability information assists users in recognizing unusual or abnormal conditions.

After the data is prepared, the data is displayed 810. In one embodiment, the data is displayed 810 by the server 702 sending the data to the client 704 for display, such as through a browser running on the client 704.

FIG. 9 illustrates a pictorial representation of a second embodiment of displaying historical traffic data. FIG. 9 includes a portion of a map with two congestion clocks 502E, 502W showing the congestion for the eastbound and westbound lanes, respectively, of a highway 906. The eastbound congestion clock 502E shows a weekday congestion period 902 from 8 to 9 am. The westbound congestion clock 502W shows a weekday congestion period 904 from 3:30 to 5 pm. In one embodiment, the congestion clocks 502 are placed adjacent the sections of road 906 with which the clocks 502 are associated. In one embodiment, this location is also where the road sensors, or data collection stations, 602 are located. In this manner, a user can quickly determine routes where congestion occurs at certain times.

In one embodiment, the congestion clocks 502 are icons displayed on a client 704. In another embodiment, the congestion clocks 502 are symbols printed on a map. In still another embodiment, the congestion clocks 502 are signs posted on a roadway, with the signs having a size and shape appropriate to be seen by a motorist traveling along a section of roadway. Congestion clocks 502 are suitable for printing as icons on roadmaps and for placement on road signs along any route where traffic data collection stations or road sensors 602 are located or where probe data is available in sufficient quantity and quality. These clocks 502, when deployed throughout a region (either by placement on road signs, printing on road maps, or both), give all travelers an opportunity to factor recurring congestion patterns into their pre-trip planning. Through-travelers are enabled to select more favorable routes, or times of day for travel, and thereby ease congestion for local traffic. Local travelers have the opportunity to change the timing and/or route of the routine trips that they make in order to avoid congestion. Everyone is enabled to make better trip planning choices, and everyone benefits. At a minimum, all freeway travelers will benefit from improved on-time reliability and trip predictability.

The methods and apparatus for presenting time-based traffic condition information includes various functions. The function of determining the traffic conditions is implemented, in one embodiment, by the road sensors 602 monitoring vehicular traffic on the roadway, a processor 604 collecting the data from the road sensors 602 and creating a set of historical time-based data. In various embodiments, the traffic conditions are representative of one or more of speed, volume, occupancy, and travel time. In another embodiment, the function of determining the traffic conditions is implemented by the processor 602 executing routines as identified in FIG. 4 and described above.

The function of representing a day graphically is implemented, in one embodiment, by a congestion clock 502, which includes a circular face with indicia 512, 514, 516, 518 indicating a time of day. FIG. 5 illustrates one embodiment of the congestion clock 502.

The function of representing a traffic condition associated with a specific roadway at a specific time is implemented, in one embodiment, by a congestion clock 502, which includes at least one annular ring with a shaded or colored area 822, 504 corresponding to a traffic condition expectation value for a specific time of day and/or day of the week.

The function of indicating a current time is implemented, in one embodiment, by the hour hand 508, which rotates and points to the indicia 512, 514, 516, 518 indicating the time of day. The hour hand 508 helps to orient the public on how to interpret the congestion clock 502 in addition to indicating the current time on a clock.

The function of displaying user selected data is implemented, in one embodiment, by the method illustrated in FIG. 8 wherein a server 702 accepts user input 802, retrieves the data 806, and sends the data for display 810 at the client 704. In another embodiment, the server 702 determines reliability information 808, which is sent for display 810 or generates a report.

From the foregoing description, it will be recognized by those skilled in the art that methods and apparatus for presenting time-based traffic condition information has been provided. In one embodiment, a congestion clock 502 is produced from data obtained from at least one road sensor. In one embodiment, the congestion clock includes annular rings with highlighted areas indicating times of congestion. In various embodiments, the time of congestion apply to one or more days of the week and the highlighted areas include information as to the degree of congestion, such as by color coding. In still another embodiment, the reliability of the time-based traffic condition information is determined and displayed and/or reported.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, we claim:

1. An apparatus for collecting and presenting traffic data, said apparatus comprising:
at least one road sensor collecting a set of traffic data from at least one lane of a road;
a processor storing said set of traffic data and creating a set of historical time-based data; and
an output from said processor, said output showing a representation of said historical time-based data, said representation of said historical time-based data including an outside circle and an inner circle defining at least one annular band, said representation including a legend representing a plurality of selected times, said representation including at least one indicium corresponding to a time of traffic congestion and located within said at least one annular band.

2. The apparatus of claim 1 wherein said output is presented on at least one of a printed map, a client computer, and a sign.

3. The apparatus of claim 1 wherein said output includes an hour hand rotating about a center of said outside circle, said hour hand indicating a current time whereby a temporal relationship between said at least one indicium and said current time is indicated.

4. The apparatus of claim 1 further including a means for indicating a current time whereby a temporal relationship between said at least one indicium and said current time is indicated.

5. The apparatus of claim 1 wherein said at least one indicium includes information indicating an amount of congestion.

6. The apparatus of claim 1 wherein said set of historical time-based data correlates data representative of at least one traffic speed, traffic volume, traffic occupancy, and travel time for a section of said road to a time of day.

7. The apparatus of claim 1 wherein said set of historical time-based data correlates data representative of at least one traffic speed, traffic volume, traffic occupancy, and travel time for a section of said road to a time of day for each day of a week.

8. The apparatus of claim 1 wherein said processor determines a reliability of said set of historical time-based data, and said output includes indicia of said reliability.

9. At least one computer programmed to execute a process for collecting and presenting traffic data, said process comprising the steps of:
acquiring a set of sensor data from a plurality of road sensors;
creating a set of historical time-based data from said set of sensor data; and
outputting said set of historical time-based data.

10. The process of claim 9 wherein said processor further executes a step of determining a reliability of said set of historical time-based data and said step of outputting includes presenting indicia of said reliability.

11. The process of claim 19 wherein said processor further executes a step of determining a reliability of said set of historical time-based data, said reliability corresponding to a comparison of said set of historical time-based data to a set of real-time data.

12. A method for collecting and presenting traffic data, said method comprising the steps of:
acquiring a set of sensor data from a plurality of road sensors monitoring a selected section of a road;
creating a set of historical time-based data from said set of sensor data; and
producing a graphical representation of said set of historical time-based data such that a traffic condition for a specific time for said selected section of said road is indicated, said graphical representation including at least one congestion clock.

13. The process of claim 12 wherein said graphical representation includes an indicium delineating said traffic condition for said selected section of said road for a specific time period, said indicium located within at least one annular band, said indicium bounded at one end in said at least one annular band at a first location corresponding to a start time, said indicium bounded at an opposite end in said at least one annular band at a second location corresponding to a stop time.

14. The process of claim 12 wherein said further executes the steps of
accepting an input from a user;
retrieving a selected set of historical time-based data;
sending said selected set of historical time-based data to a client for display.

15. The process of claim 14 further including a step of determining reliability of said selected set of historical time-based data by comparing said selected set of historical time-based data to a set of real-time data.

16. The process of claim 12 wherein said processor further executes a step of determining a reliability of said set of historical time-based data and said graphical representation includes indicia of said reliability.

17. The process of claim 12 wherein said processor further executes a step of determining a reliability of said set of historical time-based data, said reliability corresponding to a comparison of said set of historical time-based data to a set of real-time data.

18. The process of claim 12 further including indicating a current time by rotating an hour hand about said graphical representation.

19. An apparatus for presenting traffic data, said apparatus comprising:
a sign having a surface,
a first perimeter identified on said surface,
a legend representing a plurality of selected times;
at least one annular band defined within said first perimeter; and
an indicium delineating a traffic condition for a selected section of road for a specific time period, said indicium located within said at least one annular band, said indicium bounded at one end in said at least one annular band at a first location corresponding to a start time, said indicium bounded at an opposite end in said at least one annular band at a second location corresponding to a stop time.

20. The apparatus of claim 19 wherein said traffic condition represents a set of historical time-based data derived from monitoring said selected section of road.

21. The apparatus of claim 19 wherein said traffic condition represents a level of congestion on said selected section of road.

22. The apparatus of claim 19 wherein said sign is printed on a map and said sign is associated with said selected section of road displayed on said map.

23. The apparatus of claim 19 wherein said sign is attached to a support and is adapted for mounting adjacent said selected section of road.

24. The apparatus of claim 19 wherein said sign is presented on a client computer and said sign is associated with said selected section of road on said client computer.

25. The apparatus of claim 19 further including an hour hand rotating about a center of said first perimeter, said hour hand indicating a current time whereby a temporal relationship between said indicium and said current time is indicated.

26. The apparatus of claim 19 wherein said traffic condition correlates data representative of at least one traffic speed, traffic volume, traffic occupancy, and travel time for said selected section of road to a time of day.

27. The apparatus of claim 19 wherein said traffic condition correlates data representative of at least one traffic speed, traffic volume, traffic occupancy, and travel time for said selected section of road to a time of day for each day of a week.

28. The apparatus of claim 19 further including a reliability indicium whereby said reliability indicium corresponds to a comparison of a set of historical time-based data to a set of real-time data.

29. The apparatus of claim 19 further including a means for determining said traffic condition.

30. A system for presenting traffic data, said system comprising:
a means for representing a day graphically; and
a means for representing a traffic condition associated with a specific section of roadway at a specific time.

31. The apparatus of claim 30 further including a means for determining said traffic condition.

32. The apparatus of claim 30 further including a means for indicating a current time.

33. The apparatus of claim 30 further including a means for displaying user selected data.

34. A method in a computer system for communicating traffic forecast data to a user, comprising:
presenting a first prompt to the user for inputting one of a date and a day of week;
retrieving a set of historical time-based traffic data;
sending said set of historical time-based traffic data to the user; and
presenting said set of historical time-based traffic data to the user.

35. The apparatus of claim 34 further including a step of presenting a second prompt to the user for inputting one of a time and a time of day.

36. The apparatus of claim 34 further including a step of determining a reliability of said set of historical time-based traffic data by comparing said set of historical time-based traffic data to a set of real-time data.
